(19) United States
(12) Patent Application Publication
(10) Pub. No.: US 2026/0226917 A1
(43) Pub. Date: Aug. 6, 2026

(54) PORTED SHROUD CENTRIFUGAL COMPRESSOR

(71) Applicant: Ohio State Innovation Foundation, Columbus, OH (US)

(72) Inventor: Richard DEHNER, Columbus, OH (US)

(21) Appl. No.: 19/152,750

(22) PCT Filed: Jan. 30, 2024
(86) PCT No.: PCT/US2024/013501

§ 371 Date: Jul. 31, 2025

Related U.S. Application Data
(60) Provisional application No. 63/442,322, filed on Jan. 31, 2023.

(51) Int. Cl. F04D 29/42; F04D 17/10; F04D 29/68

(52) U.S. Cl. CPC F04D 29/4213; F04D 27/02; F04D 27/0207; F04D 27/023; F04D 27/0238; F04D 29/4206; F04D 29/681; F04D 29/685; F04D 17/10

(57) ABSTRACT

A ported shroud centrifugal compressor may include an annular housing defining a central opening having an inner surface, the inner surface defining an annular cavity. A ported shroud centrifugal compressor may include an annular divider disposed within the annular cavity to form a downstream slot and an upstream slot axially spaced apart from the downstream slot, wherein the downstream slot and the upstream slot are in fluid communication with the central opening and the annular cavity. A ported shroud centrifugal compressor may include an axial support extending axially across the upstream slot from the inner surface to the annular divider.

### CROSS-REFERENCE TO RELATED APPLICATIONS

This application claims the benefit of U.S. Provisional Patent Application No. 63/442,322 filed on Jan. 31, 2023, the entire contents of which are incorporated herein by reference.

### BACKGROUND

This disclosure relates to centrifugal compressors. More specifically, this disclosure relates to turbochargers, for example, as used with internal combustion engines.

### SUMMARY

In some aspects, the techniques described herein relate to a ported shroud centrifugal compressor including: an annular housing defining a central opening having an inner surface, the inner surface defining an annular cavity; an annular divider disposed within the annular cavity to form a downstream slot and an upstream slot axially spaced apart from the downstream slot, wherein the downstream slot and the upstream slot are in fluid communication with the central opening and the annular cavity; and an axial support extending axially across the upstream slot from the inner surface to the annular divider.

In some aspects, the techniques described herein relate to a ported shroud centrifugal compressor, wherein the annular divider has a divider radial thickness and a divider axial length, and wherein the divider radial thickness is less than or equal to the divider axial length.

In some aspects, the techniques described herein relate to a ported shroud centrifugal compressor, further including two axial supports.

In some aspects, the techniques described herein relate to a ported shroud centrifugal compressor, further including three axial supports.

In some aspects, the techniques described herein relate to a ported shroud centrifugal compressor, wherein the three axial supports are circumferentially spaced apart from each other, and wherein the circumferential spacing between the three axial supports is non-uniform.

In some aspects, the techniques described herein relate to a ported shroud centrifugal compressor, further including an impeller disposed within the central opening, wherein the impeller is downstream of the upstream slot.

In some aspects, the techniques described herein relate to a ported shroud centrifugal compressor, wherein the impeller is configured to cause a fluid to flow along a primary flow path through the central opening in a first direction from the upstream slot to the downstream slot, and wherein the impeller is configured to cause the fluid to flow along a secondary flow path through the annular cavity in a second direction from the downstream slot to the upstream slot.

In some aspects, the techniques described herein relate to a ported shroud centrifugal compressor, wherein the impeller has a leading edge and a trailing edge, and wherein the leading edge is closer to the downstream slot than the trailing edge.

In some aspects, the techniques described herein relate to a ported shroud centrifugal compressor, wherein the leading edge is disposed adjacent the downstream slot.

In some aspects, the techniques described herein relate to a ported shroud centrifugal compressor, wherein the axial support further extends in a circumferential direction about 2 percent to 5 percent of an inner surface circumference.

In some aspects, the techniques described herein relate to a ported shroud centrifugal compressor including: an intake; a volute coupled to the intake; an impeller positioned between the intake and the volute, the impeller defining an axis of rotation; a shroud defining a recirculation cavity that provides annular flow around the axis of rotation; a divider positioned in the recirculation cavity and cooperating with the shroud to define an upstream slot and a downstream slot, the upstream slot positioned upstream of the impeller; and an axial support coupled between the intake and the divider.

In some aspects, the techniques described herein relate to a ported shroud centrifugal compressor, further including three axial supports.

In some aspects, the techniques described herein relate to a ported shroud centrifugal compressor, wherein the three axial supports are non-uniformly circumferentially spaced.

In some aspects, the techniques described herein relate to a ported shroud centrifugal compressor, wherein the upstream slot extends around 85 percent to 94 percent of an intake circumference.

In some aspects, the techniques described herein relate to a ported shroud centrifugal compressor, wherein the intake, the axial support, and the divider are coaxial about the axis of rotation.

In some aspects, the techniques described herein relate to a ported shroud centrifugal compressor, wherein the recirculation cavity provides a continuous flow path around 360 degrees relative to the axis of rotation.

In some aspects, the techniques described herein relate to a ported shroud centrifugal compressor, wherein the shroud is formed integrally with the intake.

In some aspects, the techniques described herein relate to a ported shroud centrifugal compressor, wherein the impeller is configured to cause a fluid to flow along a primary flow path a first direction from the upstream slot to the downstream slot, and wherein the impeller is configured to cause the fluid to flow along a secondary flow path through the recirculation cavity in a second direction from the downstream slot to the upstream slot.

In some aspects, the techniques described herein relate to a ported shroud centrifugal compressor, wherein the impeller includes a leading edge and a trailing edge, wherein the leading edge is closer to the downstream slot than the trailing edge, and wherein the leading edge is disposed adjacent the downstream slot.

In some aspects, the techniques described herein relate to a ported shroud centrifugal compressor including: an intake; a volute coupled to the intake; an impeller positioned between the intake and the volute, the impeller including a leading edge and a trailing edge, and defining an axis of rotation; a shroud defining a recirculation cavity that provides annular flow around the axis of rotation; a divider positioned in the recirculation cavity and defining a divider radial thickness and a divider axial length, the divider radial thickness is less than or equal to the divider axial length, an upstream slot defined between the divider and the shroud in communication with the recirculation cavity, the upstream slot positioned upstream of the impeller; a downstream slot between the divider and the shroud in communication with the recirculation cavity, the downstream slot is closer to the leading edge of the impeller than the trailing edge; and three axial supports coupled between the intake and the divider upstream of the impeller, wherein the intake, the divider, and the three axial supports define a flush inner surface.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale,

FIG. 1 is a section view of a compressor, according to some implementations.

FIG. 2 is a front view of the compressor of FIG. 1, according to some implementations.

FIG. 3 is a top view of the compressor of FIG. 1, according to some implementations.

FIG. 4 is a left side view of the compressor of FIG. 1, according to some implementations.

FIG. 5 is a section view of the compressor taken along line 5-5 of FIG. 1, according to some implementations.

FIG. 6 is a detail view of a portion of the compressor of FIG. 5, according to some implementations.

FIG. 7 is a section view of the compressor taken along line 7-7 of FIG. 1, according to some implementations.

FIG. 8 is a detail view of a portion of the compressor of FIG. 7, according to some implementations.

FIG. 9 is a section view of the compressor taken along line 9-9 of FIG. 4, according to some implementations.

### DETAILED DESCRIPTION

Following below are more detailed descriptions of concepts related to, and implementations of, methods, apparatuses, and systems for a ported shroud centrifugal compressor. The figures illustrate exemplary implementations in detail and the present disclosure is not limited to the details or methodology set forth in the description or illustrated in the figures. The terminology used herein is for the purpose of description only and should not be regarded as limiting.

Referring to the figures generally, the various implementations disclosed herein relate to systems, apparatuses, and methods for a ported shroud centrifugal compressor (e.g., a turbocharger) that includes an annular divider upstream of an impeller. The annual divider defines an upstream slot, a downstream slot, and a recirculation chamber connecting the upstream slot and the downstream slot. The annular divider is supported via axially extending supports upstream of the impeller. The axially extending supports eliminate the need of radially extending ribs used in typical ported shroud centrifugal compressors. The elimination of radial ribs reduces noise production while improving operational efficiency.

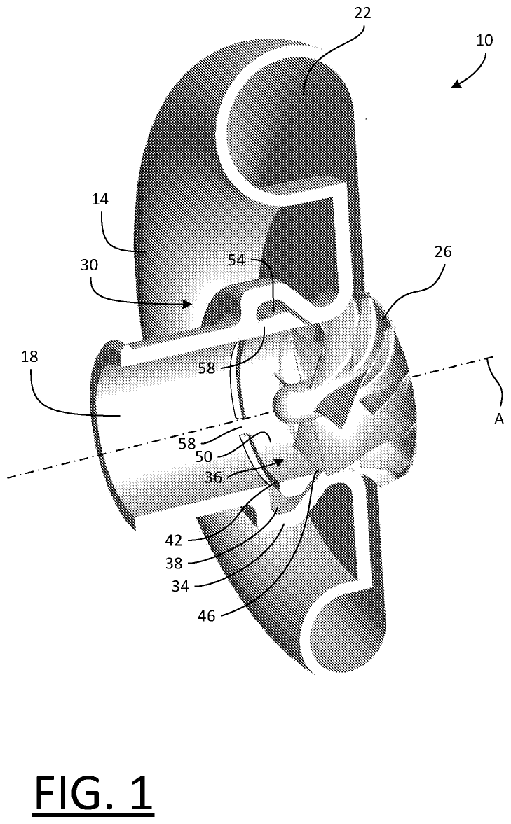

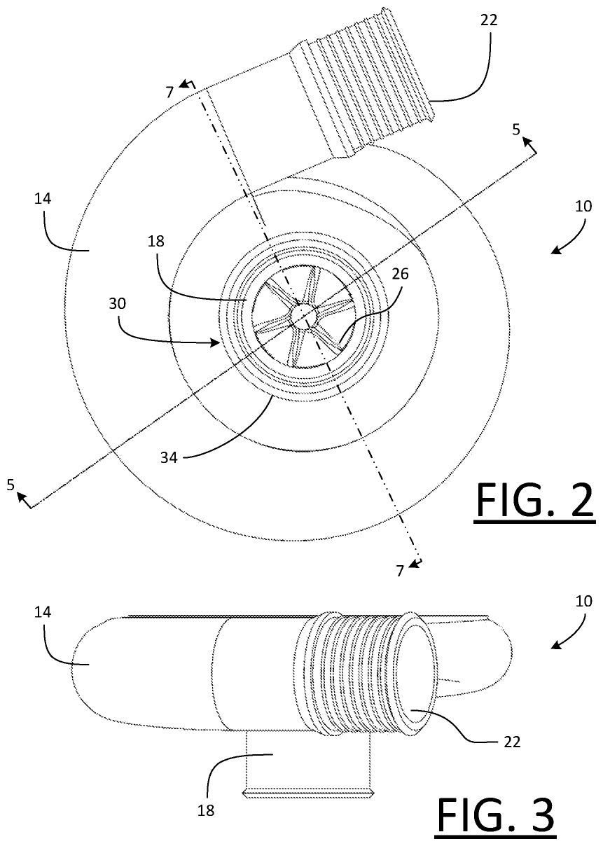

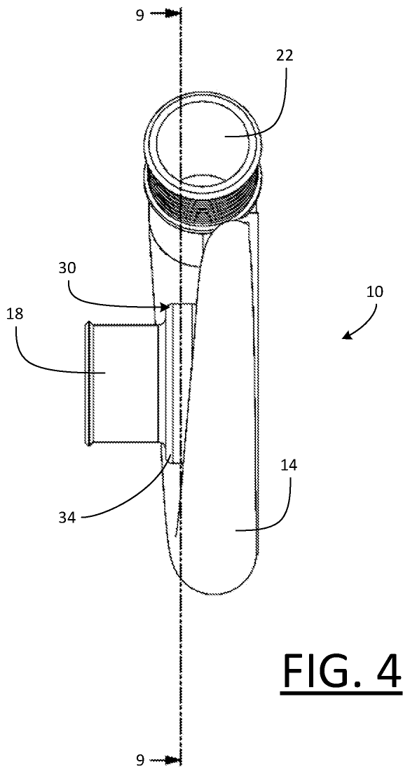

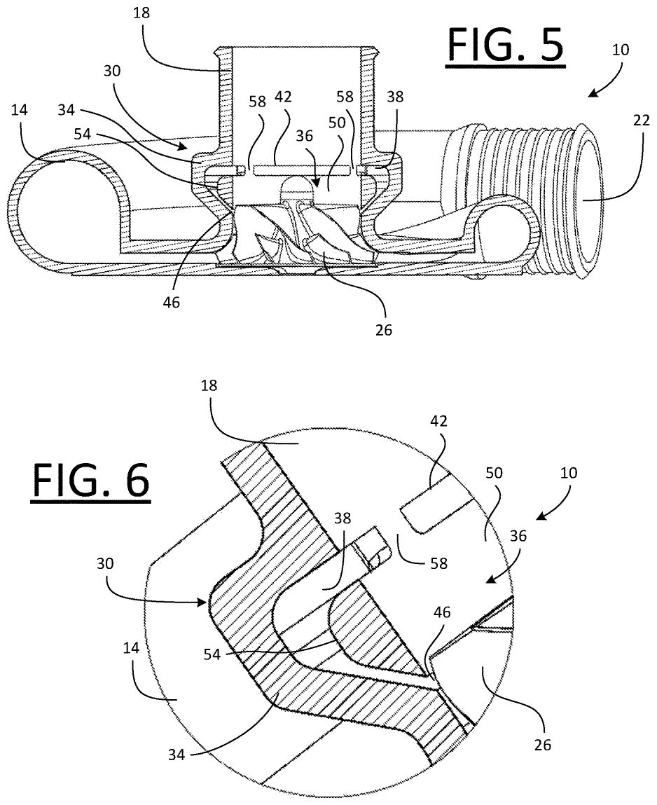

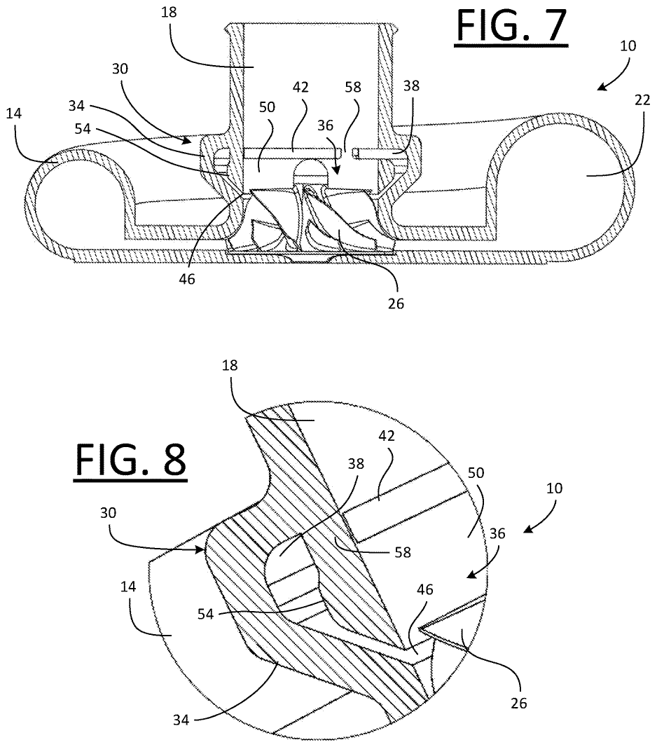

As shown in FIGS. 1-9, a ported shroud centrifugal compressor 10 includes a housing 14 that defines an intake 18 that receives uncompressed fluid (e.g., air, a fuel and gas mixture, recirculated engine emissions, etc.) and a volute 22 that provides compressed fluid. An impeller 26 is supported by the ported shroud centrifugal compressor 10 between the intake 18 and the volute 22 and defines an axis of rotation A. The impeller 26 includes a leading edge and a trailing edge. In some implementations, the housing 14 is an annular housing defining a central opening (e.g., the intake 18) having an inner surface.

Generally, fluid is received via the intake 18, compressed via the impeller 26, and exhausted from the ported shroud centrifugal compressor 10 via the volute 22 along a primary flow path. The primary flow path defines a downstream direction along the primary flow path toward the volute 22. The primary flow path also defines an upstream direction along the primary flow path toward the intake 18. A pressure of exhausted fluid can be controlled via rotational speed of the impeller 26.

A recirculation system 30 includes a recirculation housing or shroud 34 and a divider 36 defining a recirculation cavity 38 extending between an upstream slot 42 and a downstream slot 46. The recirculation cavity 38 provides a secondary flow or a recirculation flow between the downstream slot 46 and the upstream slot 42. In some implementations, the recirculation cavity 38 is an annular cavity defined by the inner surface of the central opening (e.g., the intake 18).

In some implementations, the shroud 34 extends radially beyond an external diameter of the intake 18 (as shown). In some implementations, the shroud 34 is integrally formed within the structure of the intake 18. In some implementations, the shroud 34 is a separate structure attached to the intake 18 (e.g., via fasteners or welding). In some implementations, the shroud 34 is annular. In some implementations, the shroud 34 defines a uniform profile around 360 degrees of the intake 18 with respect to the axis of rotation A.

The divider 36 is annular and defines an inner divider wall 50. In some implementations, the inner divider wall 50 is coaxial with the intake 18 about the axis of rotation A. In some implementations, the inner divider wall 50 defines a divider inner diameter that is equal to an intake inner diameter (e.g., flush). In some implementations, the inner divider wall 50 defines a divider inner diameter that is consistent or cylindrical with respect to the axis of rotation A. In some implementations, the divider inner diameter changes along the axis of rotation A (e.g., expanding or condensing). In some implementations, the divider 36 defines a recirculation path surface 54 that cooperates with the recirculation cavity 38 to define a flow profile of the recirculation flow. In some implementations, the divider 36 defines a divider radial thickness and a divider axial length, and the divider radial thickness is less than or equal to the divider axial length.

The divider 36 is maintained in place via axial supports 58 (two are visible). The axial supports 58 extend from the intake 18 toward the volute 22 parallel to the axis of rotation A. In some implementations the axial supports 58 are integrally formed with the intake 18 and the divider 36 (e.g., via a casting). In some implementations, the axial supports 58 are connected to the intake 18 and the divider 36 via fasteners, welding, adhering, or another coupling structure. In some implementations, the axial supports 58 are positioned upstream of the impeller 26 along the axis of rotation A. In some implementations, the recirculation system 30 includes three axial supports 58. In some implementations, the recirculation system 30 include more than three or less than three axial supports 58. In some implementations, the axial supports 58 define an axial support inner diameter relative to the axis of rotations A that is equal to the intake inner diameter (e.g., flush). In some implementations, the axial supports 58 define an axial support inner diameter relative to the axis of rotations A that is equal to the divider inner diameter. In some implementations, each of the axial supports 58 extends around 3.5 percent of the intake inner diameter. Therefore, the upstream slot 42 is open and provides flow into the recirculation cavity 38 around 89.5 percent of the intake inner diameter when three axial supports 58 are present. In some implementations, each of the axial supports 58 extends around 2 percent to 5 percent of the intake inner diameter.

In some implementations, the recirculation cavity 38 is annular. In some implementations, the recirculation cavity 38 defines a continuous flow path 360 degrees relative to the axis of rotation A. In some implementations, the recirculation cavity 38 provides an annular flow path with a non-uniform radial profile. For example, the recirculation cavity 38 can include baffles, ribs, or other structures and constrictions formed on the shroud 34 and/or the divider 36 while still allowing a flow path around 360 degrees relative to the axis of rotation A.

The upstream slot 42 is positioned upstream of the impeller 26 along the axis of rotations A. In some implementations, the leading edge of the impeller 26 is closer to the downstream slot 46 than the trailing edge of the impeller 26. In some implementations, the leading edge of the impeller 26 is disposed adjacent the downstream slot 46.

In some implementations, the upstream slot 42 extends around 89.5 percent of the intake inner circumference. In some implementations, the upstream slot 42 extends around 85 percent to 94 percent of the intake inner circumference. In some implementations, the upstream slot 42 extends around 75 percent to 97 percent of the intake inner circumference. In some implementations the upstream slot 42 extends around the axis of rotation A in a plane perpendicular to the axis of rotations A. In some implementations, the upstream slot 42 can define a non-circular path. For example, the upstream slot 42 can form a wave shape, a stepped shape, be arranged as an ovoid in a plane oblique to the axis of rotation A, helical, etc.

The downstream slot 46 is spaced from the upstream slot 42 by the divider 36. In some implementations, the downstream slot 46 is downstream of an upstream tip of the impeller 26. In other words, the downstream slot 46 overlaps the impeller 26 along the axis of rotation A. In some implementations, the downstream slot 46 is annular.

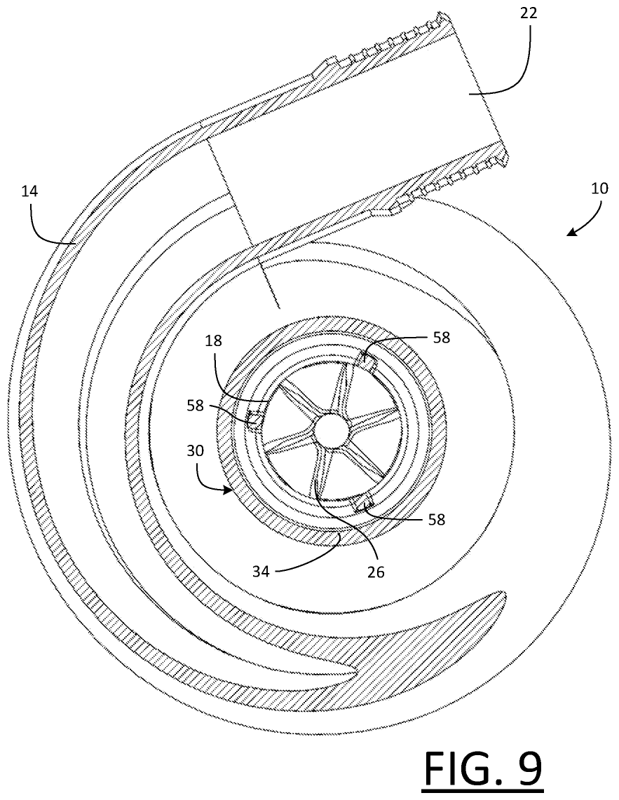

As shown in FIG. 9, the three axial supports 58 are spaced apart by non-uniform circumferential spacing. The axial supports 58 are separated by 130 degrees, 120 degrees, and 110 degrees about the circumference of the intake 18. In some implementations, the circumferential spacing is different. In some implementations, the spacing is uniform (e.g., 120 degrees, 120 degrees, 120 degrees). In some implementations, more or less than three axial supports 58 are included and the spacing therebetween can be non-uniform or uniform, as desired.

The ported shroud centrifugal compressor 10 provides a secondary, parallel flow path to recirculate flow at the intake 18. This recirculated flow increases the flow rate through the inlet of the impeller 26, which improves stability and performance at low flow operating points.

The downstream slot 46 is positioned over the impeller 26 blade tips near the intake 18 and is connected to the recirculation cavity 38. The upstream slot 42 connects the upstream side of the recirculation cavity 38 with the primary flow entering the impeller 26.

Typically, ported shroud centrifugal compressors are used for diesel (e.g., compression ignition) engines to extend the turbocharger compressor operating range at low flow rate and high pressure ratios and therefore, rotational speeds. Since turbocharged gasoline (e.g., spark ignition) engines operate at lower pressure ratios, the flow rage advantage of ported shroud compressors is traditionally less beneficial. One problem with typical centrifugal compressors is a broadband “whoosh” noise that is produced in the roughly 4-13 kHz range. This whoosh noise is common to turbocharger designs that do not include a ported shroud. Whoosh noise can be substantially reduced with the addition of a ported shroud. However, tonal noise at the impeller blade-pass frequency (BPF) is greatly increased with typical ported shroud centrifugal compressors. Increased tonal noise is well known throughout the industry to be a drawback to typical ported shroud centrifugal compressors.

The divider 36 of the ported shroud centrifugal compressor 10 separates the primary flow path into the impeller 26 and the secondary recirculation flow path. The axial supports 58 cantilever the divider 36 from the upstream side. One motivation for changing the support structure is related to the pressure and velocity field near the inlet of the impeller 26 at low flow rates.

The velocity of recirculated fluid is in the negative axial direction (e.g., opposite the primary flow in the downstream direction parallel to the axis of rotation A), and it has an even higher magnitude of tangential velocity. The recirculation cavity 38 is annular and the axial supports 58 are a less obtrusive support structure than employed by typical ported shroud centrifugal compressors. Further, the axial supports 58 are positioned further away from the impeller 26 than in typical ported shroud centrifugal compressors. The ported shroud centrifugal compressor 10 provides increased efficiency and reduced blade-pass frequency when compared to typical ported shroud centrifugal compressors. The ported shroud centrifugal compressor 10 also provides a reduced whoosh effect.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

What is claimed is:

1. A ported shroud centrifugal compressor comprising:
an annular housing defining a central opening having an inner surface, the inner surface defining an annular cavity;
an annular divider disposed within the annular cavity to form a downstream slot and an upstream slot axially spaced apart from the downstream slot, wherein the downstream slot and the upstream slot are in fluid communication with the central opening and the annular cavity; and
an axial support extending axially across the upstream slot from the inner surface to the annular divider.

2. The ported shroud centrifugal compressor of claim 1, wherein the annular divider has a divider radial thickness and a divider axial length, and
wherein the divider radial thickness is less than or equal to the divider axial length.

3. The ported shroud centrifugal compressor of claim 1, further comprising two axial supports.

4. The ported shroud centrifugal compressor of claim 1, further comprising three axial supports.

5. The ported shroud centrifugal compressor of claim 4, wherein the three axial supports are circumferentially spaced apart from each other, and
wherein the circumferential spacing between the three axial supports is non-uniform.

6. The ported shroud centrifugal compressor of claim 1, further comprising an impeller disposed within the central opening,
wherein the impeller is downstream of the upstream slot.

7. The ported shroud centrifugal compressor of claim 6, wherein the impeller is configured to cause a fluid to flow along a primary flow path through the central opening in a first direction from the upstream slot to the downstream slot, and
wherein the impeller is configured to cause the fluid to flow along a secondary flow path through the annular cavity in a second direction from the downstream slot to the upstream slot.

8. The ported shroud centrifugal compressor of claim 6, wherein the impeller has a leading edge and a trailing edge, and
wherein the leading edge is closer to the downstream slot than the trailing edge.

9. The ported shroud centrifugal compressor of claim 8, wherein the leading edge is disposed adjacent the downstream slot.

10. The ported shroud centrifugal compressor of claim 1, wherein the axial support further extends in a circumferential direction about 2 percent to 5 percent of an inner surface circumference.

11. A ported shroud centrifugal compressor comprising:
an intake;
a volute coupled to the intake;
an impeller positioned between the intake and the volute, the impeller defining an axis of rotation;
a shroud defining a recirculation cavity that provides annular flow around the axis of rotation;
a divider positioned in the recirculation cavity and cooperating with the shroud to define an upstream slot and a downstream slot, the upstream slot positioned upstream of the impeller; and
an axial support coupled between the intake and the divider.

12. The ported shroud centrifugal compressor of claim 11, further comprising three axial supports.

13. The ported shroud centrifugal compressor of claim 12, wherein the three axial supports are non-uniformly circumferentially spaced.

14. The ported shroud centrifugal compressor of claim 11, wherein the upstream slot extends around 85 percent to 94 percent of an intake circumference.

15. The ported shroud centrifugal compressor of claim 11, wherein the intake, the axial support, and the divider are coaxial about the axis of rotation.

16. The ported shroud centrifugal compressor of claim 11, wherein the recirculation cavity provides a continuous flow path around 360 degrees relative to the axis of rotation.

17. The ported shroud centrifugal compressor of claim 11, wherein the shroud is formed integrally with the intake.

18. The ported shroud centrifugal compressor of claim 11, wherein the impeller is configured to cause a fluid to flow along a primary flow path a first direction from the upstream slot to the downstream slot, and
wherein the impeller is configured to cause the fluid to flow along a secondary flow path through the recirculation cavity in a second direction from the downstream slot to the upstream slot.

19. The ported shroud centrifugal compressor of claim 11, wherein the impeller includes a leading edge and a trailing edge,
wherein the leading edge is closer to the downstream slot than the trailing edge, and
wherein the leading edge is disposed adjacent the downstream slot.

20. A ported shroud centrifugal compressor comprising:
an intake;
a volute coupled to the intake;
an impeller positioned between the intake and the volute, the impeller including a leading edge and a trailing edge, and defining an axis of rotation;
a shroud defining a recirculation cavity that provides annular flow around the axis of rotation;
a divider positioned in the recirculation cavity and defining a divider radial thickness and a divider axial length, the divider radial thickness is less than or equal to the divider axial length, an upstream slot defined between the divider and the shroud in communication with the recirculation cavity, the upstream slot positioned upstream of the impeller;
a downstream slot between the divider and the shroud in communication with the recirculation cavity, the downstream slot is closer to the leading edge of the impeller than the trailing edge; and
three axial supports coupled between the intake and the divider upstream of the impeller,
wherein the intake, the divider, and the three axial supports define a flush inner surface.
